(19) United States
(12) Patent Application Publication
(10) Pub. No.: US 2009/0064075 A1
(43) Pub. Date: Mar. 5, 2009

(54) SYSTEMS, METHODS AND COMPUTER PRODUCTS FOR SCHEMATIC EDITOR MULIT-WINDOW ENHANCEMENT OF HIERARCHICAL INTEGRATED CIRCUIT DESIGN

(75) Inventors: Blaine J. Gross, Essex Junction, VT (US); Karl L. Ladin, Rochester, MN (US); Thomas C. Perez, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/846,294

(22) Filed: Aug. 28, 2007

(51) Int. Cl. G06F 17/50

(52) U.S. Cl. 716/11

(57) ABSTRACT

A method and apparatus for displaying hierarchical navigation and editing a plurality of hierarchical levels of design of an integrated circuit includes opening a main editor screen, displaying a viewable scope of hierarchical levels of design in the main editor screen and using a computer to assign a side window adjacent to the main editor screen. The side-window displays information about schematics previously viewed including thumbnail views of most recently viewed levels of the plurality of hierarchical levels of design. Using the computer input device, the user scrolls through the main editor screen into a hierarchical level of design. The side window is populated with a schematic that was last viewed and a thumbnail view of the hierarchical level of design is surrounded by a highlighted border, enabling the user to view schematic elements underneath the hierarchical level of design and to see the thumbnail view of the top-level schematic.

### TECHNICAL FIELD

The present invention relates generally to design, development and manufacturing of integrated circuits (ICs) on semiconductor chips, for use in automated computing systems. More particularly, the present invention relates to an integrated circuit (IC) schematic editing method and tool.

### BACKGROUND

When conducting hierarchical design and physical development of ICs, circuit designers often face the problem of having voluminous smaller designs at various levels of the IC topological design hierarchy. A circuit designer often uses a schematic editor to edit the circuits in the various levels of the IC topological design hierarchy, and the designer usually has to maneuver through this hierarchy in an elementary fashion, only being able to move up or down one level of hierarchy at a time. Furthermore, while attempting to edit circuit schematics that traverse numerous design hierarchies within the same design window, all the viewable hierarchical design levels distract and may confuse the circuit designer conducting the editing process involving only a few targeted hierarchical levels. Although current electronic design automation tools offer methods of traversing design hierarchies within the same design window, none of these electronic design automation tools offer an easy interface to allow the user to traverse and edit multiple levels of design hierarchies and maintain a history of recently viewed schematics.

Therefore, the need exists for a hierarchical design navigation method and a navigation apparatus for use in schematic editing including device sizing, device editing, and other schematic modifications that are typical for those of ordinary skill in the art.

An additional need exists for a convenient design hierarchy method and device, which can save time and effort in viewing, editing and modifying design elements.

Furthermore, the need exists for a scroll mechanism to traverse design hierarchical design levels allowing circuit designers to control a definable viewable scope at different levels of design hierarchy quickly, which in turn will aid the editing process.

Further, the need exists for an editing tool that will maintain a history of recently viewed schematics during the editing process.

### SUMMARY OF THE INVENTION

A schematic editor multi-window enhancement method and an apparatus are disclosed for displaying on a computer display device, a viewable scope of an at least one hierarchical level of design from a plurality of hierarchical levels of design of an integrated circuit. The user using an input device of a computer, opens a main window of the viewable scope of the at least one hierarchical level of design, and the main window includes a main editor screen. Using the input device, the user assigns a side window that is adjacent to the main editor screen, wherein the side-window holds and displays information about a set of schematics previously viewed; wherein the set of schematics previously viewed includes thumbnail views of a set of most recently viewed levels of hierarchy of the plurality of hierarchical levels of design from a circuit book. Again using the input device, the user descends and/or scrolls, using an input device, through the main editor screen into the at least one hierarchical level of design. The system populates the side window with a schematic that was last viewed in the main editor screen and the thumbnail view of the at least one hierarchical level of design that the user descended/scrolled through is surrounded by a highlighted border, thereby, enabling the user to view schematic elements underneath the at least one hierarchical level of design that the user descended/scrolled through and also enabling the user to see the thumbnail view of the top-level schematic that is contained in the at least one hierarchical level of design. When the user using the input device descends/scrolls through the main editor screen, into one of an other hierarchical level of design of the plurality of hierarchical levels of design, the main editor screen is refreshed by the system and associated thumbnail views are refreshed with a set of schematics that are underneath the other hierarchical level of design, wherein the user, using the input device, moves the input device between multiple levels of hierarchy at a time through the side window, and visual feedback of what schematics have been either viewed or edited is provided to the user. In addition, the side window includes a quantity of one or more windows, and these one or more are user configurable by the user using clicking the input device. Plus, the items in the side window are clickable, and are selected by the user clicking on the items, using the input device and thereby bringing the selected item back into the at least one hierarchical level of design in the main editor screen, and whereby the user controls the input device to perform a useful, concrete and tangible result of traversing the viewable scope of the at least one hierarchical level of design and conducting an editing operation of the integrated circuit under test, without distractions from voluminous levels of IC topological information, of the plurality of hierarchical levels of design.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings, which are meant to be exemplary, and not limiting, wherein:

FIG. 1 illustrates operations in a method for the display of hierarchical navigation in the automated editing of integrated circuits under test.

FIG. 2 illustrates a viewable scope of hierarchical levels of design as defined in a main editing window including side windows.

FIG. 3 illustrates the system implementing the operations illustrated in FIG. 1.

### DETAILED DESCRIPTION

Exemplary embodiments of a method and an apparatus are disclosed for display of hierarchical navigation in the design automation process of the design, physical development and manufacturing of integrated circuits including head and tail pointers used to define the viewable scope of the desired design hierarchy to be traversed. The disclosed exemplary embodiments are intended to be illustrative only, since numerous modifications and variations therein will be apparent to those of ordinary skill in the art. In reference to the drawings, like numbers will indicate like parts continuously throughout the view. Further, the terms “a”, “an”, “first”, and “third” herein do not denote limitations of quantity, but rather denote the presence of one or more of the referenced item(s).

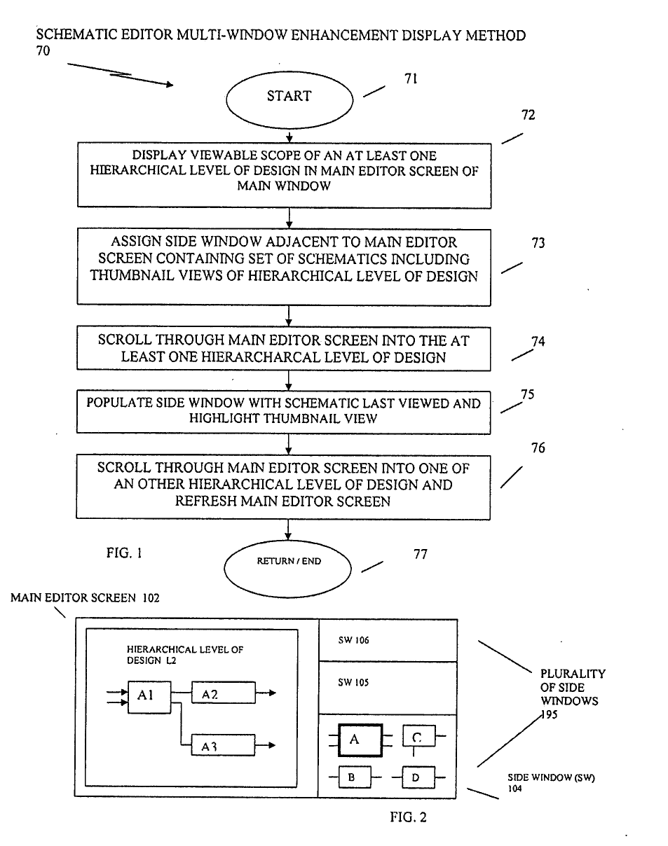

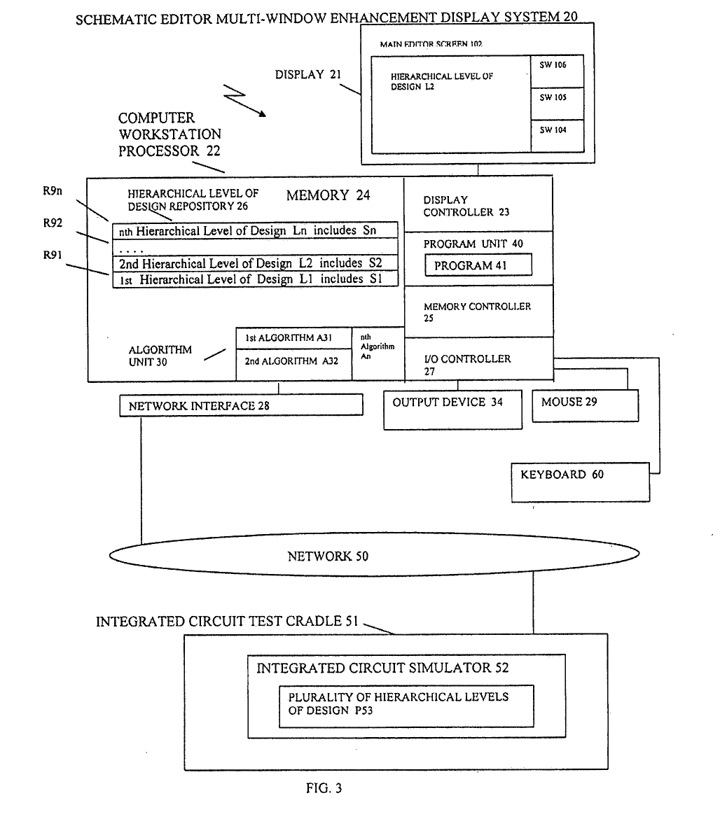

A schematic editor multi-window enhancement display method 70 (herein referred to as “method 70”) and a schematic editor multi-window enhancement display system 20 (herein referred to as “system 20”) implementing method 70 are illustrated in FIGS. 1 and 3 respectively. A main editor screen 102 and a plurality of side windows 195, where the plurality of side windows 195 includes at least side window 104, side window 105 and side window 106 (herein referred to interchangeably as SW 104, SW 105 and SW 106) are illustrated in FIG. 2 and FIG. 3.

Referring to FIG. 2 and FIG. 3, system 20 includes computer workstation processor 22, which contains memory 24, as illustrated in FIG. 3. Algorithm unit 30 resides in memory 24 and contains a plurality of algorithms including first algorithm A31 and second algorithm A32 up to nth algorithm An. Also, residing in system 20 is program unit 40, containing program 41. Memory 24 also contains hierarchical level of design repository 26, which contains a plurality of repository entry locations R91, R92 and up to Rn, which hold hierarchical levels of design L1, L2 up to Ln and schematics S1, S2 up to Sn respectively. In addition, the hierarchical levels of design L1, L2 up to Ln contain element items. In the exemplary embodiment, hierarchical level of design L2 contains element items A1, A2 and A3, as illustrated in FIG. 2, where element items A1, A2 and A3 are first, second and third instances of the hierarchical level of design L2, and are included in hierarchical cell A, which is illustrated as a highlighted cell in side window 106. The highlighted condition of cell A is indicated by a bold border around the cell, as well as the highlighted cell having a larger size than cells B, C and D.

In the exemplary embodiment, system 20 includes a combination of controllers including display controller 23, memory controller 25 and input/output (I/O) controller 27 and a combination of computer peripheral devices cooperatively coupled to system 20 including display 21, a set of input devices including keyboard 60 and mouse 29, network interface 28, and output device 34, via standard interface connectivity. Network interface 28 cooperatively couples computer workstation processor 22 via network 50 to integrated circuit test cradle 51. An integrated circuit simulator 52 is plugged into integrated circuit test cradle 51 to undergo testing and debugging exercises, as well as schematic design editing.

The schematic of the integrated circuit simulator 52 has a three dimensional layered topology of viewable design data comprising a plurality of hierarchical levels of design P53, including hierarchical levels of design L1, L2 up to Ln. Display 21 displays the plurality of hierarchical levels of design P53, when no limited viewable scope of hierarchical levels of design have been defined and set for viewing by the operator/user. In the alternative, display 21 displays only the viewable scope of hierarchical levels of design, which have been defined and set for viewing by the operator/user. By not displaying the viewable scope of the plurality of hierarchical levels of design, operator/user fatigue is reduced, causing the operator/user to make fewer mistakes in editing the schematics of the plurality of hierarchical levels of design of the IC under test 52, during the IC design and development process.

Referring to FIG. 1 and FIG. 3 at operation start 71, the operator/user activates program 41, where method 70 is stored as program code on a computer executable medium. The operator/user activates program 41 and performs other selections in method 70 by making entries using any one of input devices including keyboard 60 or mouse 29. At operation start 71, the user makes a selection via an input device to activate program 41; thus, causing program 41 to be executed by computer workstation processor 22. At operation 72, program 41, executed by system 20, causes the system to open a main editor screen 102 on the display device 21, where a viewable scope of an at least one hierarchical level of design L2 is displayed in the main editor screen 102.

At operation 73, using either of the input devices, i.e., either keyboard 60 or mouse 29 to input side window parameters into program 41, the user assigns side window parameters input into program 41, thereby enabling program 41, when executed by computer workstation processor 22 to open the plurality of side windows 195 adjacent to the main editor screen 102, wherein the plurality of side windows 195 hold and display information about a set of schematics previously viewed, and wherein the set of schematics previously viewed include thumbnail views of a set of most recently viewed levels of hierarchy of the plurality of hierarchical levels of design from a circuit book. In the exemplary embodiment illustrated in FIG. 2, side window 104 holds/displays thumbnail views of previously viewed cells of hierarchical level of design L2, including cell A, cell B, cell C and cell D.

At operation 74, using an input device, such as either keyboard 60 or mouse 29, the user interacts with program 41 which enables the user to scroll through the main editor screen 102 into the at least one hierarchical level of design of the plurality of hierarchical levels of design P53 of the integrated circuit simulator 52.

At operation 75, in association with the user scrolling through the main editor screen 102, program 41 causes the system to populate the side windows 195 with thumbnail views of a schematic S1 of the at least one hierarchical level of design that was last viewed in the main editor screen 102 and also causes the thumbnail view of the schematic A of the at least one hierarchical level of design L2 that the user scrolled through to be surrounded by a highlighted border and appears larger in size, thereby, enabling the user to view schematic elements underneath the at least one hierarchical level of design L2 that the user scrolled through and also enabling the user to see the thumbnail view of the top-level schematic S2 that is contained in the at least one hierarchical level of design L2.

At operation 76, using an input device, such as either keyboard 60 or mouse 29, the user interacts with program 41 which enables the user to scroll through the main editor screen 102 into one of another hierarchical level of design of the plurality of hierarchical levels of design L1, L2 up to Ln. When the user using the input device, scrolls through the main editor screen 102, into one of an other hierarchical level of design of the plurality of hierarchical levels of design L1, L2 up to Ln, the main editor screen 102 is refreshed by method 70 and associated thumbnail views are refreshed with a set of schematics that are underneath the other hierarchical level of design, wherein the user, using the input device, such as either keyboard 60 or mouse 29, moves the input device between multiple levels of hierarchy at a time through side window 104, and visual feedback of what schematics have been either viewed or edited is provided to the user. In the exemplary embodiment, the plurality of side windows 195 includes a quantity of one or more side windows 104, 105 and 106, and these one or more windows 104, 105 and 106 are user configurable by the user clicking the input device, such as either keyboard 60 or mouse 29. Thus, the cells A, B, C and D in side window 104 are clickable, and are selected by the user clicking on the elements/items, using the input device, such as either keyboard 60 or mouse 29 and thereby bringing cell items A1, A2 and A3 of the selected cell A back into the at least one hierarchical level of design L2 in the main editor screen 102, and whereby the user controls the input device, such as either keyboard 60 or mouse 29 to perform a useful, concrete and tangible result of traversing the viewable scope of the at least one hierarchical level of design and conducting an editing operation of the integrated circuit schematic being viewed, without distractions from voluminous levels of IC topological information, of the plurality of hierarchical levels of design L1, L2 up to Ln.

At return/end operation 77, method 70 repeatedly returns to operation 72 where the viewable scope of additional hierarchical levels of design of the plurality of hierarchical levels of design L1, L2 up to Ln can be defined by further assigning of side windows including side windows 105 and 106 containing additional schematics from the set of schematics, where additional iterations of the scrolling through the main editor screen 102 into an at least one hierarchical level of design of the plurality of hierarchical levels of design L1, L2 up to Ln and populating the plurality of side windows 195 are performed by the operator/user. Alternatively in the exemplary embodiment, at return/end operation 77, in accordance with method 70, the user can end the operation of method 70, by deactivating program 41 and ending the IC design navigation and editing session.

While the disclosure has been described with reference to an exemplary method and system embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

What is claimed is:

1. A method of displaying hierarchical navigation and editing a plurality of hierarchical levels of design in an automated design of an integrated circuit, the method comprising:
displaying, on a display device of a computer, a viewable scope of an at least one hierarchical level of design from a plurality of hierarchical levels of design, when the user using an input device of a computer, opens a main editor screen which displays the viewable scope of the at least one hierarchical level of design;
assigning a side window, by the user, using the input device, that is adjacent to the main editor screen, wherein the side window displays information about a set of schematics previously viewed; wherein the set of schematics previously viewed includes thumbnail views of a set of most recently viewed levels of hierarchy of the plurality of hierarchical levels of design from a circuit book,
scrolling, by the user, using the input device, through the main editor screen into the at least one hierarchical level of design;
populating the side window with a schematic that was last viewed, wherein the thumbnail view includes a highlighted border surrounding the at least one hierarchical level of design that the user scrolled through, and wherein the user can view schematic elements underneath the at least one hierarchical level of design that the user scrolled through and can see the thumbnail view of the top-level schematic that is contained in the at least one hierarchical level of design; and
scrolling, by the user using the input device, through the main editor screen, into one of an other hierarchical level of design of the plurality of hierarchical levels of design, wherein the main editor screen is refreshed and associated thumbnail views are refreshed with a set of schematics that are underneath the other hierarchical level of design, wherein the user, using the input device, moves the input device between multiple levels of hierarchy at a time through the side window, wherein visual feedback of what schematics have been one of viewed and edited is provided to the user, wherein the side window comprises a quantity of one or more windows, wherein the quantity of one or more windows in the side window are user configurable by the user clicking the input device, wherein items in the side window are clickable, and are selected by the user clicking, using the input device, on the item and bringing the selected item back into the at least one hierarchical level of design in the main editor screen, and wherein the user controls the input device to perform a useful, concrete and tangible result of traversing the viewable scope of the at least one hierarchical level of design and conducting an editing operation of the integrated circuit under test, without distractions from voluminous levels of IC topological information, of the plurality of hierarchical levels of design.

2. The method according to claim 1, further comprising performing one of ending the hierarchical level of design navigation and editing in the integrated circuit automated design operation and repeating the hierarchical level of design navigation in the integrated circuit automated design operation for different hierarchical levels of design of the plurality of hierarchical levels of design.

3. A system for displaying hierarchical navigation and editing a plurality of hierarchical levels of design in an automated design of an integrated circuit, the system comprising:
a computer workstation processor;
a combination of computer peripheral devices connected to the computer workstation processor, where the combination of computer peripheral devices includes a display, a set of input devices including a keyboard and a mouse, an output device, and a network interface, where the network interface connects to a network, where the network is connected to an integrated circuit test cradle containing the integrated circuit under test, and the integrated circuit under test contains a plurality of hierarchical levels of design;
a combination of controllers residing in the computer workstation processor, where the combination of controllers includes a display controller, a memory controller and an input/output controller;
a memory, a program unit and an algorithm unit residing in the computer workstation processor, where the memory contains a repository for the hierarchical levels of design, the algorithm unit contains a plurality of algorithms and the program unit contains a program that when executed by the computer workstation processor, causes the computer workstation processor to:
displaying, on a display device of a computer, a viewable scope of an at least one hierarchical level of design from a plurality of hierarchical levels of design, when the user using an input device of a computer, opens a main editor screen which displays the viewable scope of the at least one hierarchical level of design;
assigning a side window, by the user, using the input device, that is adjacent to the main editor screen, wherein the side window displays information about a set of schematics previously viewed; wherein the set of schematics previously viewed includes thumbnail views of a set of most recently viewed levels of hierarchy of the plurality of hierarchical levels of design from a circuit book,
scrolling, by the user, using the input device, through the main editor screen into the at least one hierarchical level of design;
populating the side window with a schematic that last viewed, wherein the thumbnail view includes a highlighted border surrounding the hierarchical level of design that the user scrolled through, and wherein the user can view schematic elements underneath the at least one hierarchical level of design that the user scrolled through and can see the thumbnail view of the top-level schematic that is contained in the at least one hierarchical level of design; and
scrolling, by the user using the input device, through the main editor screen, into one of an other hierarchical level of design of the plurality of hierarchical levels of design, wherein the main editor screen is refreshed and associated thumbnail views are refreshed with a set of schematics that are underneath the other hierarchical level of design, wherein the user, using the input device, moves the input device between multiple levels of hierarchy at a time through the side window, wherein visual feedback of what schematics have been one of viewed and edited is provided to the user, wherein the side window comprises a quantity of one or more windows, wherein the quantity of one or more windows in the side window are user configurable by the user clicking the input device, wherein items in the side window are clickable, and are selected by the user clicking, using the input device, on the item and bringing the selected item back into the at least one hierarchical level of design in the main editor screen, and wherein the user controls the input device to perform a useful, concrete and tangible result of traversing the viewable scope of the at least one hierarchical level of design and conducting an editing operation of the integrated circuit under test, without distractions from voluminous levels of IC topological information, of the plurality of hierarchical levels of design.

4. The system according to claim 3, wherein the program that when executed by the computer workstation processor, causes the computer workstation processor to: perform one of ending the hierarchical level of design navigation and editing in the integrated circuit automated design operation and repeating the hierarchical level of design navigation in the integrated circuit automated design operation for different hierarchical levels of design of the plurality of hierarchical levels of design.
